(19) United States
(12) Patent Application Publication
(10) Pub. No.: US 2012/0104985 A1
(43) Pub. Date: May 3, 2012

(54) STEPPING MOTOR DRIVE UNIT

(76) Inventors: Masako Yamada, Osaka (JP); Daijiro Arisawa, Kyoto (JP)

(21) Appl. No.: 13/195,634

(22) Filed: Aug. 1, 2011

(30) Foreign Application Priority Data
Oct. 29, 2010 (JP) 2010-243515

(51) Int. Cl. H02P 8/00

(52) U.S. Cl. 318/696

(57) ABSTRACT

In a stepping motor drive unit which drives a stepping motor including coils having a plurality of phases, and has functions of causing both ends of one of the coils having one of the plurality of phases to have high impedance to detect an inductive voltage in the coil, and determining a rotation/stop state of the stepping motor based on a result of the detection, the stepping motor drive unit has a function of temporarily stopping, while causing the both ends of the coil having the one of the plurality of phases to have high impedance, PWM driving of at least one of the other coils to fix an energized state of the coil.

### CROSS-REFERENCE TO RELATED APPLICATION

This application claims priority to Japanese Patent Application No. 2010-243515 filed on Oct. 29, 2010, the disclosure of which including the specification, the drawings, and the claims is hereby incorporated by reference in its entirety.

### BACKGROUND

The present disclosure relates to a stepping motor drive unit, and more particularly relates to a stepping motor drive unit having a rotor stop determination function.

In an optical disc apparatus, after the power is turned on, disc information in an innermost circumference of an optical disc has to be read before a data read operation or a data write operation is performed. However, when the optical disc apparatus is started, an optical pickup is not necessarily located at a predetermined position, and therefore, a read sequence is started after the optical pickup is moved to an innermost circumference or an outermost circumference of an optical disc to adjust a reference position. Similarly, in another optical disc apparatus using three-wavelength laser including blue laser, a spherical aberration correction lens has to be moved to adjust a reference position at the time of starting the optical disc apparatus.

It can be detected using a detection means such as an optical sensor and a contact switch, etc. that an optical pickup or a spherical aberration correction lens has reached a target position. However, the cost of such a detection means is relatively high as compared to that of a driver IC of a drive motor (a stepping motor) for an optical pickup or a spherical aberration correction lens. Therefore, a rotor stop determination function is provided to a motor drive IC to reduce members such as an optical sensor and a contact switch, etc., thereby cutting the cost of the entire optical disc apparatus.

In general, an inductive voltage is generated at a motor coil when a rotor is rotated, and an inductive voltage is not generated when the rotor is stopped. Thus, when an optical pickup or a spherical aberration correction lens is moved, an inductive voltage is generated at a coil of a drive motor. Specifically, an inductive voltage reaches a peak value near a zero crossing of a coil current. On the other hand, when the optical pickup or the spherical aberration correction lens reaches a stopping member and can no longer move, an inductive voltage is not generated. There have been stepping motor drive units configured based on the above-described point so that zero crossing of a coil current are detected, both ends of the coil are caused to have high impedance during a predetermined period, and an inductive voltage generated at the coil is detected, thereby determining whether a rotor is stopped or not (see, for example, Japanese Patent Publication No. 2009-65806).

FIG. 9 illustrates a configuration of a conventional stepping motor drive unit. The stepping motor drive unit drives a two-phase (phase A and phase B) bipolar stepping motor 100. A phase A output section 110 and a phase B output section 120 respectively drive a phase A coil 101 and a phase B coil 102 in a PWM mode according to a phase A input signal and a phase B input signal. The phase A input signal and the phase B input signal are analog signals or digital signals, each exhibiting a current waveform of a substantially sine wave that should be supplied to each coil, and have phases that are out of phase with one another by an electrical angle of 90 degrees. Each of the phase A output section 110 and the phase B output section 120 receives a high impedance control signal HiZ to cause both ends of an associated one of the phase A coil 101 and the phase B coil 102 to have high impedance regardless of the phase A input signal and the phase B input signal. A detection control section 130 receives a phase A detection control signal to output HiZ to the phase A output section 110 and output a detection period signal Det to a phase A inductive voltage detection section 140, and receives a phase B detection control signal to output HiZ to the phase B output section 120 and output a detection period signal Det to a phase B inductive voltage detection section 150. The phase A detection control signal and the phase B detection control signal are signals respectively indicating zero crossing detection results for currents flowing through the phase A coil 101 and the phase B coil 102, and are output from phase zero crossing detection sections (not shown). Each of the phase A inductive voltage detection section 140 and the phase B inductive voltage detection section 150 receives Det to detect a voltage across both ends of an associated one of the phase A coil 101 and the phase B coil 102. A stop determination section 160 determines, based on the detection results of the phase A inductive voltage detection section 140 and the phase B inductive voltage detection section 150, whether a rotor 103 of the stepping motor 100 is stopped or not.

There are various driving schemes such as one-phase excitation driving, two-phase excitation driving, one-two phase excitation driving, and micro-step driving, etc. for two-phase bipolar stepping motors. In any one of such driving schemes, when rotor stop determination is performed, both ends of a coil having a phase with which an inductive voltage is to be detected have to be caused to have high impedance, and a coil having another phase has to be energized. Micro-step driving will be described as an example below.

FIG. 10 shows waveforms of various signals for the stepping motor drive unit of FIG. 9. FIG. 11 shows waveforms in which a high impedance period in FIG. 10 is increased. In micro-step driving, the rotor 103 is smoothly rotated at constant speed, and therefore, an inductive voltage has a waveform with a sinusoidal characteristic relative to a rotation angle and reaches a peak near a zero crossing of a load current. The both ends of each of the phase A coil 101 and the phase B coil 102 are caused to have high impedance in a certain period from each edge of an associated one of the phase A detection control signal and the phase B detection control signal, and inductive voltage is detected (indicated by circles in FIG. 10). A residual current which is left in each coil when the coil is caused to have high impedance is discharged by a free wheel diode and a parasitic diode of a CMOS transistor, etc. Therefore, immediately after the both ends have been caused to have high impedance, the voltage across the both ends of the coil is at a value obtained by adding a power supply voltage and a diode clamp voltage, but when the residual current is discharged, the voltage across the both ends of the coil gradually converges to the value of the inductive voltage (see, for example, FIG. 11). Then, if the positive value of the inductive voltage detected when the voltage across the both ends of the coil has converged to a certain extent is higher than the positive value of a determination voltage, or if the negative value of the inductive voltage is lower than the negative value of the determination voltage, it is determined that the rotor 103 is not stopped, i.e., the rotor 103 is rotated. On the other hand, the detected inductive voltage is substantially zero, it is determined that the rotor 103 is stopped.

The present inventors found the following points regarding stepping motor drive units.

When the coil having one phase is caused to have high impedance, the coil having the other phase is energized in order to supply a torque to the rotor 103. In many cases, to reduce heat generated in a switching element, PWM driving is performed to energize the coil having the other phase. In PWM driving, a coil current repeatedly increases and decreases with a gradient according to a time constant of the coil at all the time, but is constant as an approximate value or an average value. In this case, because the coil in which inductive voltage is detected and the other coil driven in PWM mode are located close to each other for structural reasons, a generated voltage due to mutual inductance between the coils is superimposed on the inductive voltage. In FIG. 11, a differential voltage of the phase B coil does not have a waveform indicated by a broken line, but has a waveform indicated by a solid line due to the mutual inductance. Rotor stop determination is performed to determine whether a detected inductive voltage is equal to or higher than a certain level or not. If an inductive voltage varies each time the current direction in the other coil is changed due to the mutual inductance, it is difficult to perform accurate stop determination. In other driving schemes, an inductive voltage is also detected when the current phase or the current direction is changed. The coil in which inductive voltage is not detected is also influenced by the mutual inductance by PWM drive in a similar manner, and it is also difficult to perform accurate stop determination therein.

As the size of optical disc apparatuses is reduced, motors having a reduced size have become widely used. Therefore, an inductive voltage generated at a coil is reduced due to reduction in size of motor coils. On the other hand, since coils having different phases are placed close to each other, the influence of the mutual inductance of the coils tends to be increased. As a result, for example, if the phase B coil is driven in a PWM mode when the both ends of the phase A coil are caused to have high impedance in order to observe an inductive voltage generated in the phase A coil, large noise caused by PWM driving of the phase B coil is superimposed on the inductive voltage generated in the phase A coil, so that the inductive voltage in the phase A coil might not be correctly observed and an error in rotor stop determination might be caused.

### SUMMARY

A stepping motor drive unit according to the present disclosure may be advantageous to highly accurate rotor stop determination.

As an example embodiment, a stepping motor drive unit which drives a stepping motor including coils having a plurality of phases includes: a phase A output section configured to drive a phase A coil in a PWM mode according to a phase A input signal, cause, when receiving a high impedance control signal, both ends of the phase A coil to have high impedance regardless of the phase A input signal, and fix, when receiving an energized state fixing signal, an energized state of the phase A coil regardless of the phase A input signal; a phase B output section configured to drive a phase B coil in a PWM mode according to a phase B input signal, cause, when receiving a high impedance control signal, both ends of the phase B coil to have high impedance regardless of the phase B input signal, and fix, when receiving an energized state fixing signal, an energized state of the phase B coil regardless of the phase B input signal; a phase A detection control section configured to receive a phase A detection control signal to output the high impedance control signal to the phase A output section and output the energized state fixing signal to the phase B output section; a phase B detection control section configured to receive a phase B detection control signal to output the high impedance control signal to the phase B output section and output the energized state fixing signal to the phase A output section; a phase A inductive voltage detection section configured to receive a detection period signal to detect a voltage across the both ends of the phase A coil; a phase B inductive voltage detection section configured to receive a detection period signal to detect a voltage across the both ends of the phase B coil; and a stop determination section configured to determine, based on determination results of the phase A inductive voltage detection section and the phase B inductive voltage detection section, whether a rotor of the stepping motor is stopped or not. The phase A output section outputs, after receiving the energized state fixing signal from the phase B detection control section, the detection period signal to the phase B inductive voltage detection section in synchronization with a driving timing of the phase A coil. Also, the phase B output section outputs, after receiving the energized state fixing signal from the phase A detection control section, the detection period signal to the phase A inductive voltage detection section in synchronization with a driving timing of the phase B coil.

As another example embodiment, a stepping motor drive unit which drives a stepping motor including coils having a plurality of phases includes: a phase A output section configured to drive a phase A coil in a PWM mode according to a phase A input signal, cause, when receiving a high impedance control signal, both ends of the phase A coil to have high impedance regardless of the phase A input signal, and fix, when receiving an energized state fixing signal, an energized state of the phase A coil regardless of the phase A input signal; a phase B output section configured to drive a phase B coil in a PWM mode according to a phase B input signal, cause, when receiving a high impedance control signal, both ends of the phase B coil to have high impedance regardless of the phase B input signal, and fix, when receiving an energized state fixing signal, an energized state of the phase B coil regardless of the phase B input signal; a phase A detection control section configured to receive a phase A detection control signal to output the high impedance control signal to the phase A output section and output the energized state fixing signal to the phase B output section; a phase B detection control section configured to receive a phase B detection control signal to output the high impedance control signal to the phase B output section and output the energized state fixing signal to the phase A output section; a phase A inductive voltage detection section configured to receive a detection period signal to detect a voltage across the both ends of the phase A coil; a phase B inductive voltage detection section configured to receive a detection period signal to detect a voltage across the both ends of the phase B coil; a phase A detection period control section configured to receive the energized state fixing signal from the phase A detection control section to output the detection period signal to the phase A inductive voltage detection section; a phase B detection period control section configured to receive the energized state fixing signal from the phase B detection control section to output the detection period signal to the phase B inductive voltage detection section; and a stop determination section configured to determine, based on determination results of the phase A inductive voltage detection section and the phase B inductive voltage detection section, whether a rotor of the stepping motor is stopped or not.

According to the stepping motor drive unit having one of the above-described configurations, PWM driving of the coil having a phase which is not caused to have high impedance when detection of an inductive voltage is performed is temporarily stopped, and an energized state of the coil is fixed, so that noise due to mutual inductance can be reduced. Thus, the stepping motor drive unit itself can perform highly accurate rotor stop determination.

### BRIEF DESCRIPTION OF THE DRAWINGS

FIG. 1 is a block diagram of a stepping motor drive unit according to a first embodiment.

FIG. 2 is a block diagram illustrating a configuration for a phase A output section and a phase B output section shown in FIG. 1.

FIG. 3 is a timing chart showing timings of signals for the stepping motor drive unit of the first embodiment.

FIG. 4 is a timing chart showing the operation of the stepping motor drive unit of the first embodiment.

FIG. 5 is a block diagram of a stepping motor drive unit according to a second embodiment.

FIG. 6 is a block diagram illustrating a configuration for a phase A output section and a phase B output section shown in FIG. 5.

FIG. 7 is a timing chart showing timings of signals for the stepping motor drive unit of the second embodiment.

FIG. 8 is a timing chart showing the operation of the stepping motor drive unit according to the second embodiment.

FIG. 9 is a block diagram illustrating a configuration of a conventional stepping motor drive unit.

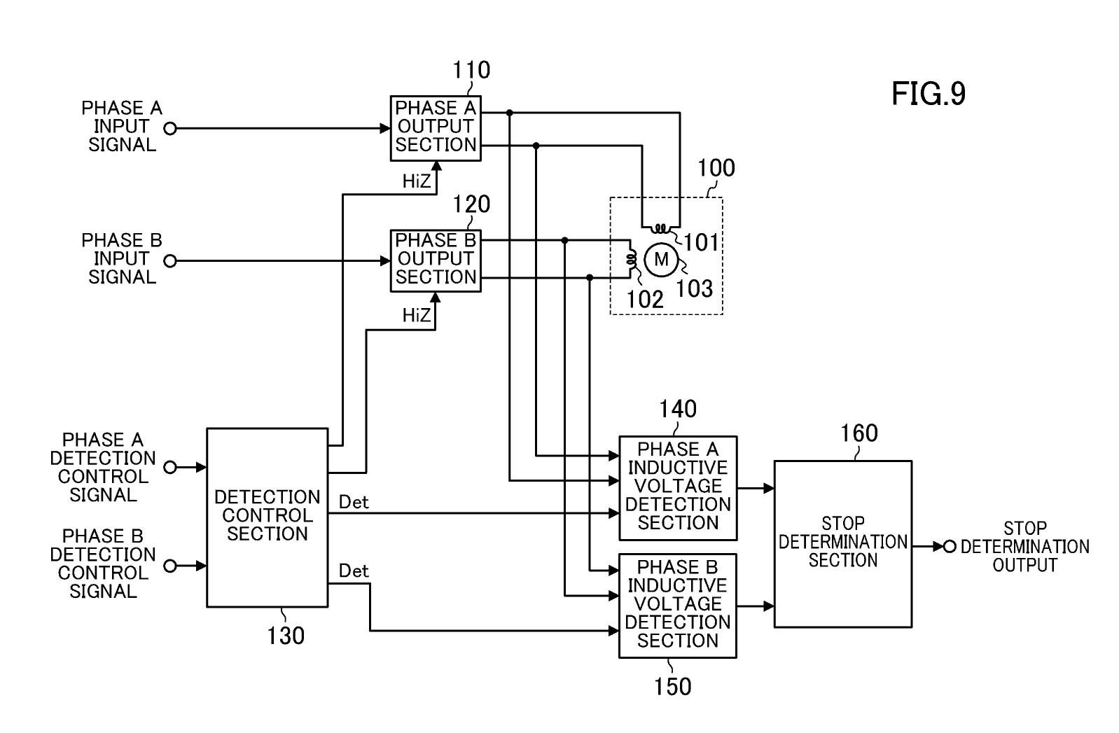

FIG. 10 is a waveform chart showing waveforms of signals in the stepping motor drive unit.

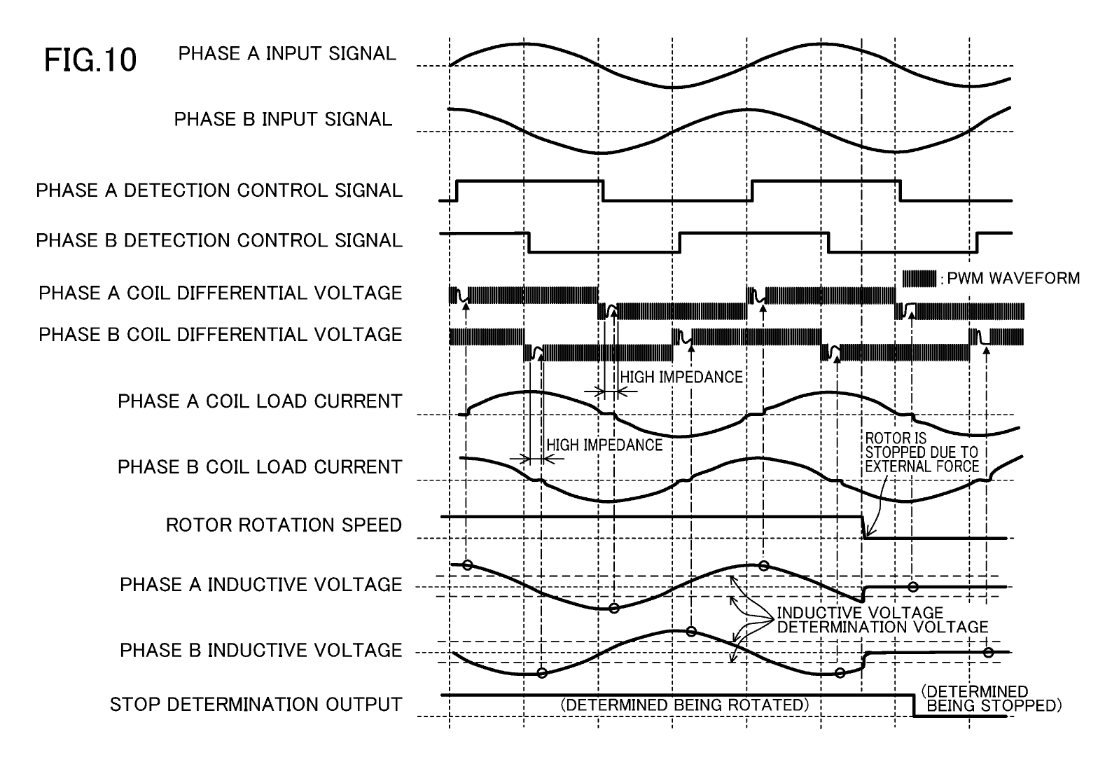

FIG. 11 is a waveform chart showing waveforms of signals in which a high impedance period in FIG. 10 is increased.

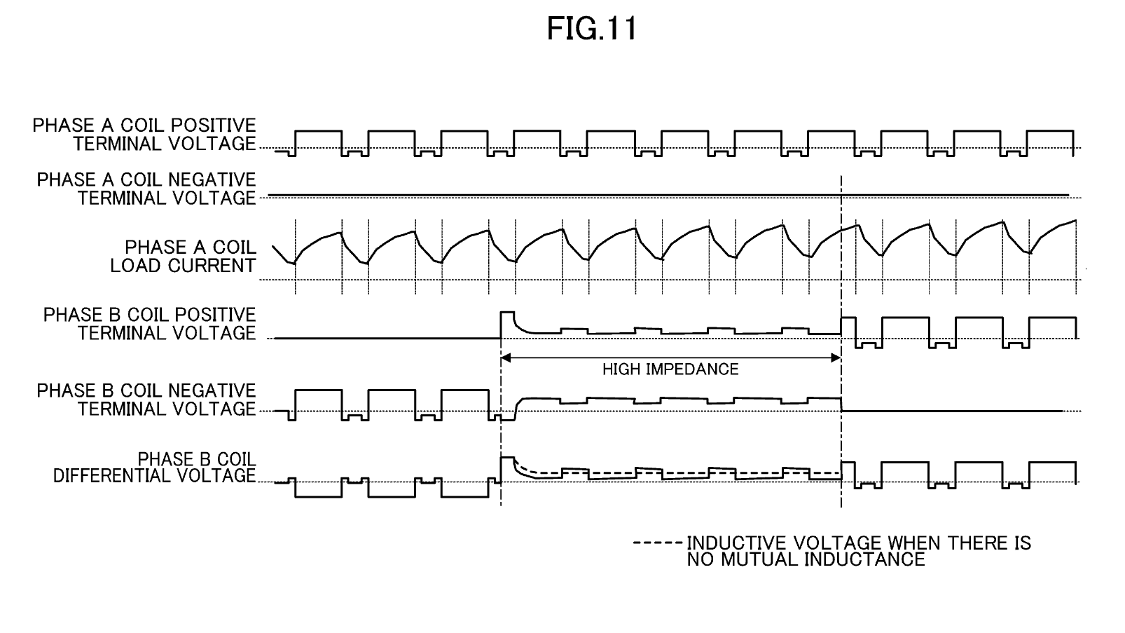

### DETAILED DESCRIPTION

### First Embodiment

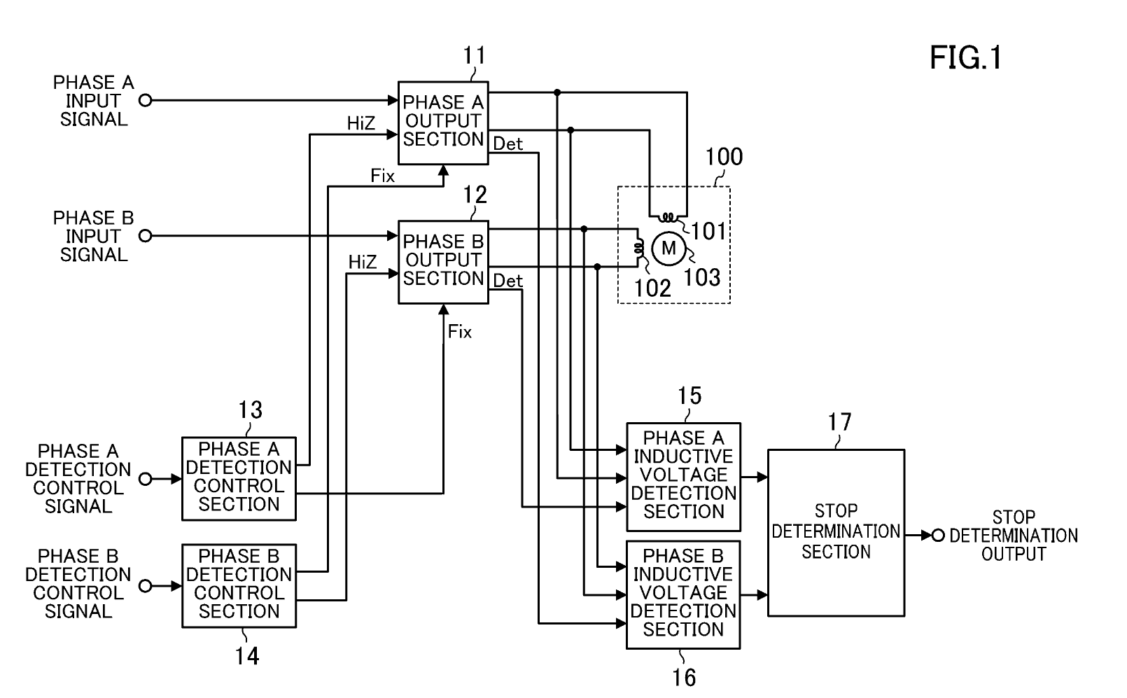

FIG. 1 illustrates a configuration of a stepping motor drive unit according to a first embodiment. For example, the stepping motor drive unit drives a two-phase (phase A and phase B) bipolar stepping motor 100. A phase A output section 11 drives a phase A coil 101 of the stepping motor 100 in the PWM mode according to a phase A input signal. A phase B output section 12 drives a phase B coil 102 of the stepping motor 100 in the PWM mode according to a phase B input signal. The phase A input signal and the phase B input signal are analog signals or digital signals, each exhibiting a current waveform of a substantially sine wave that should be supplied to each coil, and have phases that are out of phase with one another by an electrical angle of 90 degrees.

When the phase A output section 11 receives a high impedance control signal HiZ, the phase A output section 11 causes both ends of the phase A coil 101 to have high impedance regardless of the phase A input signal, and when the A phase output section 11 receives an energized state fixing signal Fix, the A phase output section 11 fixes an energized state of the phase A coil 101 regardless of the phase A input signal. Furthermore, the phase A output section 11 receives Fix, and then, outputs a detection period signal Det to a phase B inductive voltage detection section 16 in synchronization with driving timing of the phase A coil 101. When the phase B output section 12 receives a high impedance control signal Hiz, the phase B output section 12 causes both ends of the phase B coil 102 to have high impedance regardless of the B input signal, and when the phase B output section 12 receives an energized state fixing signal Fix, the phase B output section 12 fixes an energized state of the phase B coil 102 regardless of the phase B input signal. Furthermore, the phase B output section 12 receives Fix, and then, outputs a detection period signal Det to a phase A inductive voltage detection section 15 in synchronization with driving timing of the phase B coil 102.

A phase A detection control section 13 receives a phase A detection control signal to output Hiz to the phase A output section 11 and output Fix to the phase B output section 12. A phase B detection control section 14 receives a phase B detection control signal to output Hiz to the phase B output section 12 and output Fix to the phase A output section 11.

The phase A inductive voltage detection section 15 receives Det to detect a voltage across the both ends of the phase A coil 101. The phase B inductive voltage detection section 16 receives Det to detect a voltage across the both ends of the phase B coil 102. A stop determination section 17 determines whether a rotor 103 of the stepping motor 100 is stopped or not, based on detection results of the phase A inductive voltage detection section 15 and the phase B inductive voltage detection section 16.

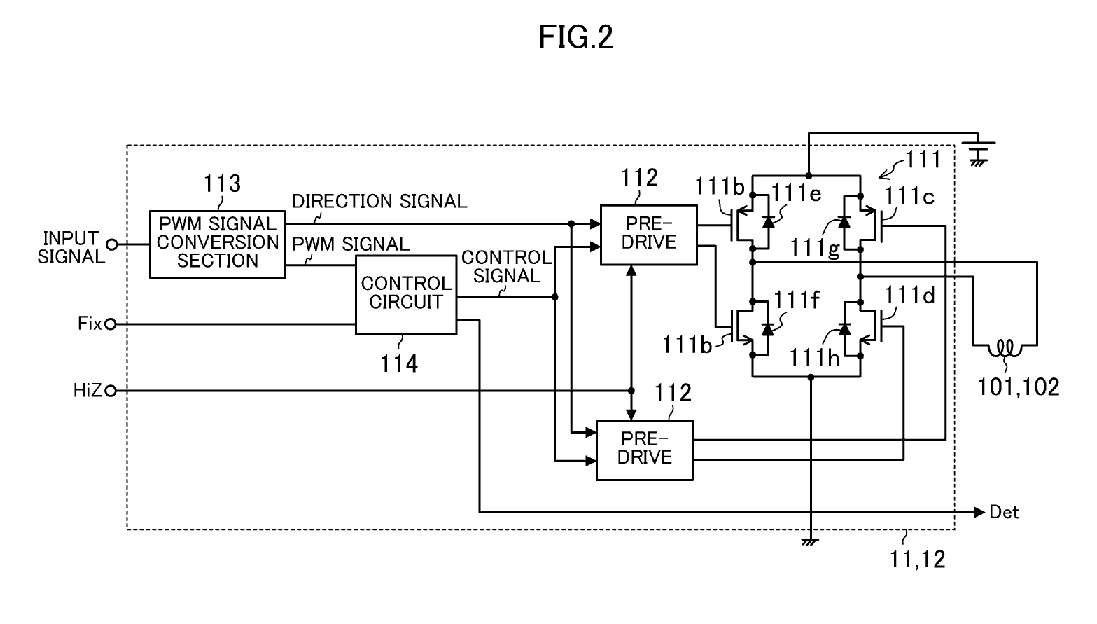

FIG. 2 is a block diagram illustrating a specific example configuration for the phase A output section 11 and the phase B output section 12. The phase A output section 11 and the phase B output section 12 each include an H bridge circuit 111 which drives the phase A coil 101 and the phase B coil 102, two pre-drives 112 which control the H bridge circuit 111, a PWM signal conversion section 113 which converts an input signal into a PWM signal and a direction signal, and a control circuit 114 which receives the PWM signal and Fix to output a control signal to control the pre-drives 112 and output Det.

The H bridge circuit 111 includes four power transistors 111a, 111b, 111c, and 111d each of which is made of a MOS transistor. The two pre-drives 112 drive the transistors 111a, 111b, 111c, and 111d according to the direction signal output from the PWM signal conversion section 113 and the control signal output from the control circuit 114. Note that, it goes without saying that driving timings of a pair of the transistors 111a and 111b and a pair of the transistors 111c and 111d are adjusted so that a flow-through current does not pass through each of the pairs. Also, according to the direction signal, a current flow direction is determined so that when an output of one of the phase A output section 11 and the phase B output section 12 is chopped, an output of the other one of the phase A output section 11 and the phase B output section 12 drives an associated one of the coils in the PWM mode in a state where a low-side transistor or a high-side transistor is fixed in an on state.

When the two pre-drives 112 receive HiZ, the pre-drives 112 perform control to turn off all of the transistors 111a-111d. When an output is caused to have high impedance, a residual current in a motor coil rapidly increases a voltage across the coil due to the inductance of the coil, is regenerated to the power supply source and the ground by parasitic diodes 111e, 111f, 111g, and 111h of the transistors 111a-111d, and disappears from the motor coil. Note that the transistors 111a-111d may be replaced with a combination of a switching element such as a bipolar transistor and an IGBT, etc., and a rectifying device such as a diode and a Schottky, etc.

Returning to FIG. 1, each of the phase A detection control section 13 and the phase B detection control section 14 receives an associated one of the phase A detection control signal and the phase B detection control signal to start a sequence for detecting an inductive voltage generated in an associated one of the phase A coil 101 and the phase B coil 102. When the phase A detection control section 13 receives the phase A detection control signal, the phase A detection control section 13 performs control to cause the phase A output section 11 to have high impedance. After a lapse of time which allows stable detection of an inductive voltage generated by rotation of the rotor 103 from the time when a residual current in the phase A coil 101 which has been necessary for driving phase A coil 101 has been caused to disappear by the above-described rectifying device, the phase A detection control section 13 gives an energized state fixing signal Fix to cause an output to be in a state where a high-side transistor is fixed to an on state or a state where a low-side transistor is fixed to an on state to the phase B output section 12.

After receiving Fix, the phase B output section 12 detects a timing at which a PWM signal generated at the PWM signal conversion section 113 transitions from L to H or H to L. When the PWM signal is H, the high-side transistor which performs a chopping operation is fixed to the on state. When the PWM signal is L, the low-side transistor is fixed to the on state. When the PWM signal transitions from H or L, the high-side transistor or the low-side transistor is fixed to the on state during a specified time period from the transition. While the high-side transistor or the low-side transistor is fixed to the on state, the PWM signal is disregarded. Then, when the PWM signal transitions from L to H or H to L, Det is output during the time period in which the high-side transistor or the low-side transistor is fixed to the on state.

On the other hand, when the phase B detection control section 14 receives the phase B detection control signal, the phase B detection control section 14 performs control to cause the phase B output section 12 to have high impedance. After a lapse of time which allows stable detection of an inductive voltage generated by rotation of the rotor 103 from the time when a residual current in the phase B coil 102 which has been necessary for driving phase B coil 102 has been caused to disappear by the above-described rectifying device, the phase B detection control section 14 gives an energized state fixing signal Fix to cause an output to be in a state where a high-side transistor is fixed to an on state or a state where a low-side transistor is fixed to an on state to the phase A output section 11.

After receiving Fix, the phase A output section 11 detects timing at which a PWM signal generated at the PWM signal conversion section 113 transitions from L to H or H to L. When the PWM signal is H, the high-side transistor performing a chopping operation is fixed to an on state. When the PWM signal is L, the low-side transistor is fixed to an on state. When the PWM signal transitions from H or L, the high-side transistor or the low-side transistor is fixed to the on state during a specified time period from the transition. While the high-side transistor or the low-side transistor is fixed to the on state, the PWM signal is disregarded. Then, when the PWM signal transitions from L to H or H to L, Det is output during the time period in which the high-side transistor or the low-side transistor is fixed to an on state.

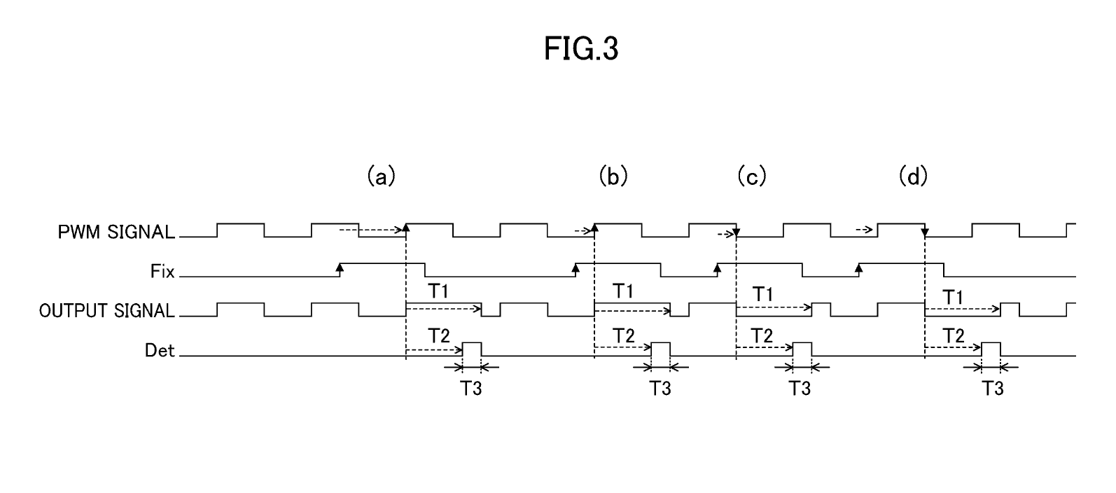

Next, the relationship of the PWM signal, Fix, and Det in the stepping motor drive unit of this embodiment will be described. FIG. 3 is a timing chart showing timings of signals for the stepping motor drive unit of this embodiment. FIG. 3 shows that, when the PWM signal and an output signal are L, the low-side transistor performing a chopping operation is on, and when the PWM signal and the output signal are H, the high-side transistor performing a chopping operation is on. Note that an example where the phase A detection control signal is input will be described below, but even when the phase B detection control signal is input, the PWM signal, Fix, and Det have the same relationship as described below.

An operation when Fix is active and a high-side transistor is fixed to an on state is shown by (a) and (b) in FIG. 3. There is no change during a period from the time when a signal to cause a state where a high-side transistor is fixed to an on state is input to the time when the PWM signal is changed from a state where a low-side transistor is on to the state where the high-side transistor is on, and the high-side transistor is fixed to the on state during a specified time period from the time when the PWM signal is changed to the state where the high-side transistor is on. In this fixed state, when the PWM signal is changed to the state where the low-side transistor is on, an output signal maintains the state where the high-side transistor is on. Also, if the specified time elapses as the PWM signal is in the state where the high-side transistor is on, the PWM signal and the output signal are the same signal. When the specified time period ends, the output signal passes through the PWM signal.

When the PWM signal is changed from the state where the low-side transistor is on to the state where the high-side transistor is on, an output is fixed during the specified time T1, and the phase B output section 12 sends a detection timing (a signal Det) to the phase A inductive voltage detection section 15 during the specified time T1. The phase A inductive voltage detection section 15 detects a differential voltage across the phase A coil 101 during the period in which the phase A inductive voltage detection section 15 receives Det. Then, the phase A inductive voltage detection section 15 detects whether the detected voltage signal has specified voltage polarity and voltage value or not, and sends detection results to the stop determination section 17.

After Fix which is a signal to fix a high-side transistor to an on state is turned to H, an output is fixed to a state where the high-side transistor is on during a specified time period from the timing where the PWM signal has transitioned from L to H and, after a lapse of a time T2 which is shorter than the specified time, Det which is a detection timing is output to perform detection. A time T3 is a time period in which Det is H, and even which this pulse is output, Fix is not released. That is, the relationship T1≧T2+T3 holds.

An operation when Fix is active and a low-side transistor is fixed to an on state is shown by (c) and (d) in FIG. 3. There is no change during a period from the time when a signal to cause a state where a low-side transistor is fixed to an on state is input to the time when the PWM signal is changed from a state where a high-side transistor is on to the state where the low-side transistor is on and, and the low-side transistor is fixed to an on state during a specified time period from the time when the PWM signal is changed to the state where the low-side transistor is on. In this fixed state, even when the PWM signal is changed to the state where the high-side transistor is on, an output signal maintains the state where the low-side transistor is on. Also, if the specified time elapses as the PWM signal is in the state where the low-side transistor is on, the PWM signal and the output signal are the same signal. When the specified time period ends, the output signal passes through the PWM signal.

When the PWM signal is changed from the state where the high-side transistor is on to the state where the low-side transistor is on, an output is fixed during the specified time T1, and the phase B output section 12 sends a detection timing (a signal Det) to the phase A inductive voltage detection section 15 during the specified time T1. The phase A inductive voltage detection section 15 detects a differential voltage across the phase A coil 101 during the period in which the phase A inductive voltage detection section 15 receives Det. Then, the phase A inductive voltage detection section 15 detects whether the detected voltage signal has specified voltage polarity and voltage value or not, and sends detection results to the stop determination section 17.

After Fix which is a signal to fix a low-side transistor to an on state is turned to H, an output is fixed to a state where the low-side transistor is on during a specified time period from the time when the PWM signal transitions from H to L and, after a lapse of a time T2 which is shorter than the specified time, Det which is a detection timing is output to perform detection. A time T3 is a time period in which Det is H, and even while this pulse is output, Fix is not released. That is, the relationship T1≧T2+T3 holds.

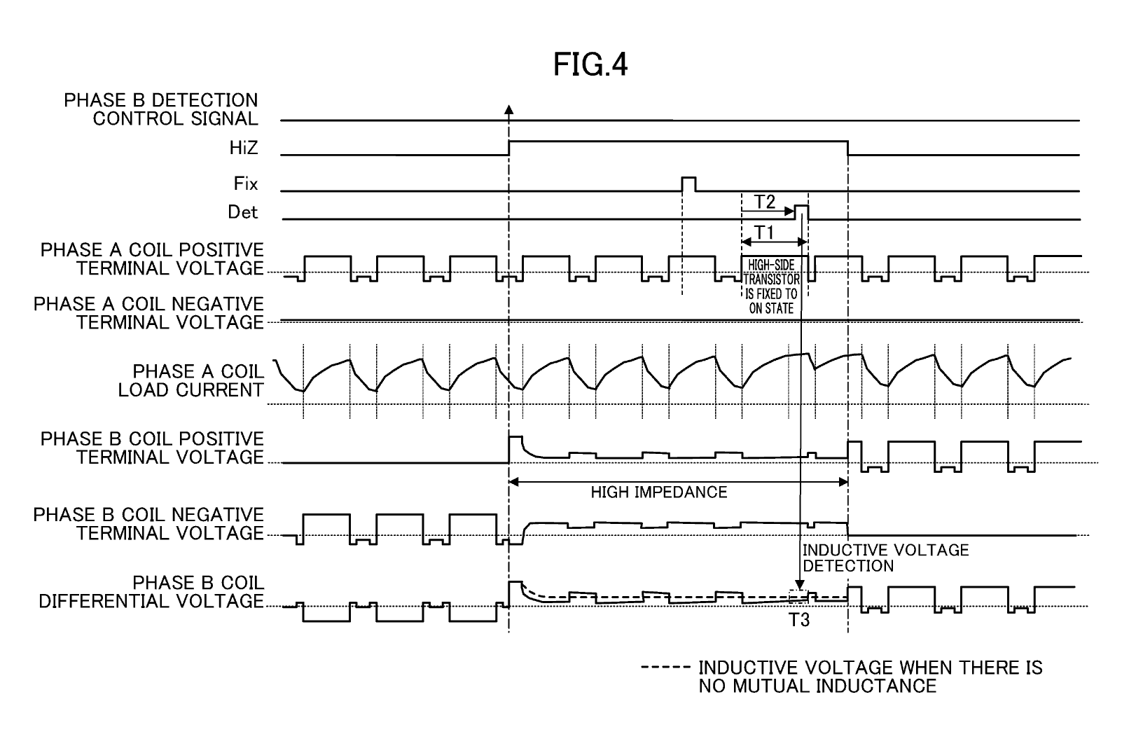

Next, an operation of the stepping motor drive unit of this embodiment will be described with reference to FIG. 4. Detection of an inductive voltage of the phase B coil 102 will be described below as an example. Immediately before detection is performed, each of the phase A output section 11 and the phase B output section 12 performs PWM driving to energize an associated one of the coils. When the phase B detection control signal is input, the both ends of the phase B coil 102 coupled to the phase B output section 12 are caused to have high impedance. Since a residual current in the phase B coil 102 is regenerated by diodes, a differential voltage reaches a level equal to or higher than the power supply voltage, but after discharge is completed, the differential voltage starts converging to a value of an inductive voltage generated by rotation of the rotor 103. At this time, since the phase A coil 101 is driven in the PWM mode, a voltage due to mutual inductance is superimposed on an inductive voltage generated in the phase B coil 102. Thereafter, Fix is input to the phase A output section 11, so that an output is fixed during a certain amount of time from a rising edge of the PWM signal and energizing is continued at least during T1.

Since the coil has a time constant due to the inductance and resistance value, the amount of increase in current gradually reduces as energizing is continued. The mutual inductance is in proportion to a derivative value of a current, and therefore, when the amount of increase in current reduces, the influence of the mutual inductance reduces. After a lapse of a time T2 in which the influence of the mutual inductance is sufficiently reduced relative to the inductive voltage, Det is output. Accordingly, detection of an inductive voltage generated in the phase B coil 102 is performed, so that the influence of the mutual inductance can be reduced. It goes without saying that, since the amount of change in fixed energized state gradually reduces even in the direction in which an electric current reduces, similar advantages can be achieved. When detection is completed, the phase A output section 11 restarts PWM driving of the phase A coil 101.

As described above, according to this embodiment, an inductive voltage can be detected with a timing at which the influence of mutual inductance is small. Thus, rotor stop determination can be performed with high accuracy. Also, in a motor for which stop determination conventionally has to be performed at relatively high rotation speed, determination can be performed at lower rotation speed. Moreover, an energized state can be fixed in synchronization with a timing of PWM driving, so that rotor stop determination can be performed while smooth motor driving is continued.

### Second Embodiment

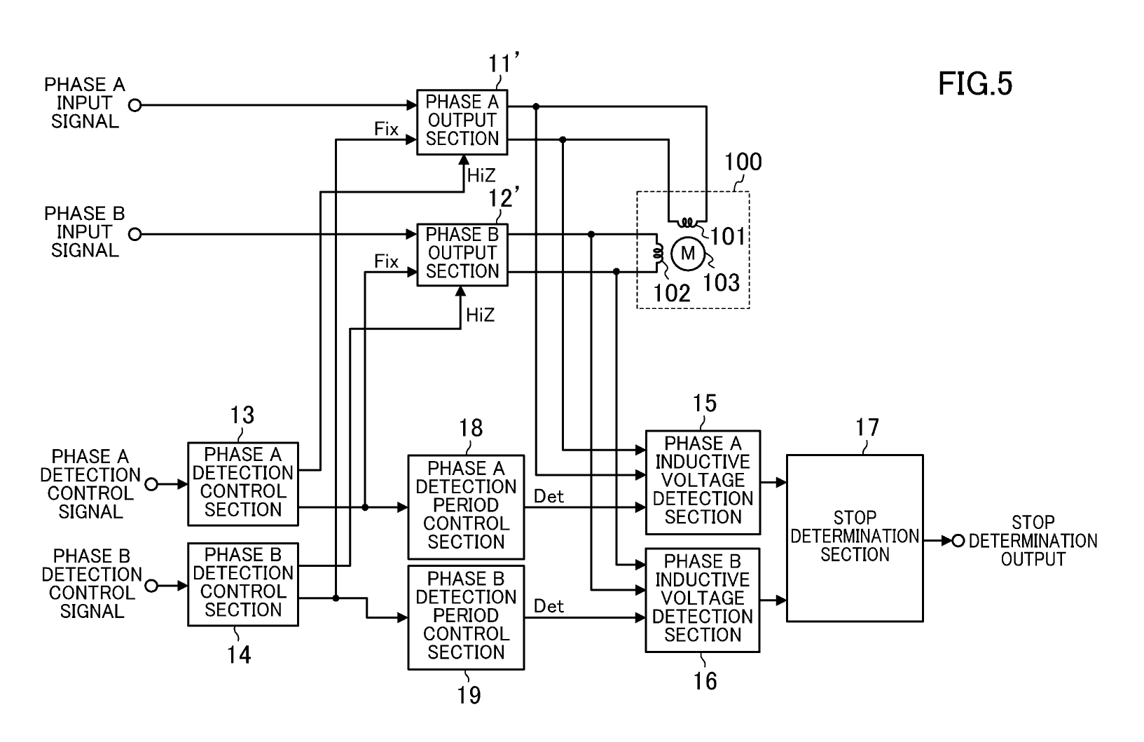

FIG. 5 is a block diagram of a stepping motor drive unit according to a second embodiment. The stepping motor drive unit of this embodiment is different from the stepping motor drive unit of the first embodiment in that the phase A output section 11 and the phase B output section 12 are replaced with a phase A output section 11′ and a phase B output section 12′, and that a phase A detection period control section 18 and a phase B detection period control section 19 are added to the configuration of the first embodiment. Only differences of this embodiment from the first embodiment will be described in detail below.

The phase A detection period control section 18 receives an energized state fixing signal Fix from the phase A detection control section 13 to output a detection period signal Det to the phase A inductive voltage detection section 15. The phase B detection period control section 19 receives an energized state fixing signal Fix from the phase B detection control section 14 to output a detection period signal Det to the phase B inductive voltage detection section 16. Note that each of the phase A detection period control section 18 and the phase B detection period control section 19 preferably outputs the detection period signal Det after a lapse of a predetermined time from reception of the Fix from an associated one of the phase A detection control section 13 and the phase B detection control section 14.

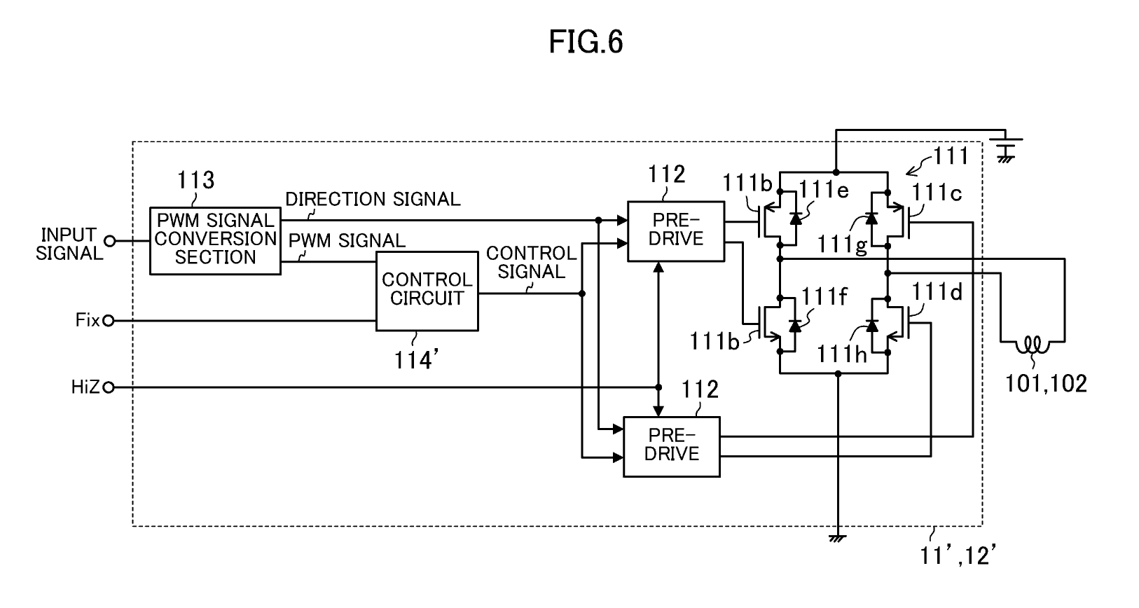

The phase A output section 11′ and the phase B output section 12′ are different from the phase A output section 11 and the phase B output section 12 in the stepping motor drive unit of the first embodiment, and do not output the detection period signal Det. FIG. 6 is a block diagram illustrating a specific example configuration for the phase A output section 11′ and the phase B output section 12′. A control circuit 114′ generates a control signal for the two pre-drives 112 but does not generate Det.

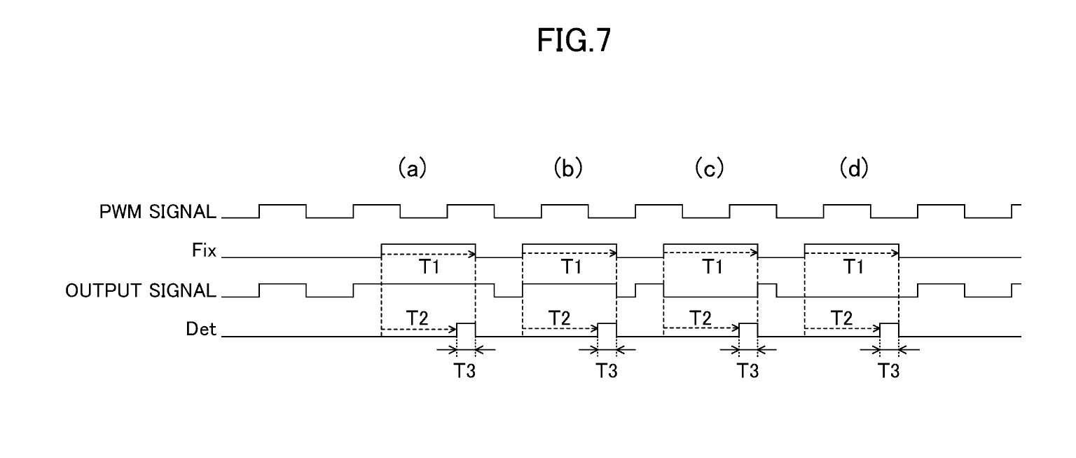

Next, the relationship of the PWM signal, Fix, and Det in the stepping motor drive unit of this embodiment will be described. FIG. 7 is a timing chart showing timings of signals for the stepping motor drive unit of this embodiment. FIG. 7 shows that, when the PWM signal and an output signal are L, the low-side transistor performing a chopping operation is on, and when the PWM signal and the output signal are H, the high-side transistor performing a chopping operation is on. Note that an example where the phase A detection control signal is input will be described below, but even when the phase B detection control signal is input, the PWM signal, Fix, and Det have the same relationship as described below.

An operation when Fix is active and a high-side transistor is fixed to an on state is shown by (a) and (b) in FIG. 7. When the output exhibiting a chopping characteristic is output with the low-side transistor fixed to an on state at the moment of input of a signal to cause a state where the high-side transistor is fixed to an on state, an output signal is changed to the state where the high-side transistor is on. Also, when the output exhibiting a chopping characteristic is output with the high-side transistor fixed to an on state at the moment of input of the signal to cause a state where the high-side transistor is fixed to an on state, an output signal maintains the state where the high-side transistor is on.

The phase A detection period control section 18 receives the signal to cause the state where the high-side transistor is fixed to an on state to send, after a specified time, a detection timing (a signal Det) to the phase A inductive voltage detection section 15. The phase A inductive voltage detection section 15 detects a differential voltage across the phase A coil 101 during the period in which the phase A inductive voltage detection section 15 receives Det. Then, the phase A inductive voltage detection section 15 detects whether the detected voltage signal has specified voltage polarity and voltage value or not, and sends detection results to the stop determination section 17. When the detection is completed, the phase A output section 11′ releases a high impedance state to restart normal PWM driving.

When Fix is H, H is output as an output signal regardless of the PWM signal. When Fix is L, the output signal passes through a PWM signal. Fix fixes an output to a state where a high-side transistor is on during the period of the time T1. Then, after being delayed from a rising edge of Fix by a time T2, Det is output to perform detection. A time T3 is a time period in which Det is H, and even while this pulse is output, Fix is not released. That is, the relationship T1≧T2+T3 holds.

An operation when Fix is active and then a low-side transistor is fixed to an on state is shown by (c) and (d) in FIG. 7. When the output exhibiting a chopping characteristic is output with a low-side transistor fixed to an on state at the moment of input of a signal to cause a state where the low-side transistor is fixed to an on state, an output signal maintains the state where the low-side transistor is on. Also, when the output exhibiting a chopping characteristic is output with a high-side transistor fixed to an on state at the moment of input of the signal to cause the state where the low-side transistor is fixed to an on state, an output signal is changed to the state where the low-side transistor is on.

The phase A detection period control section 18 receives the signal to cause the state where the low-side transistor is fixed to an on state to send, after a specified time, a detection timing (a signal Det) to the phase A inductive voltage detection section 15. The phase A inductive voltage detection section 15 detects a differential voltage across the phase A coil 101 during the period in which the phase A inductive voltage detection section 15 receives Det. Then, the phase A inductive voltage detection section 15 detects whether the detected voltage signal has specified voltage polarity and voltage value or not, and sends detection results to the stop determination section 17. When the detection is completed, the phase A output section 11′ releases a high impedance state to restart normal PWM driving.

When Fix is H, L is output as an output signal regardless of the PWM signal. When Fix is L, the output signal passes through a PWM signal. Fix fixes an output to a state where a low-side transistor is on during the period of the time T1. After being delayed from a rising edge of Fix by the time T2, Det is output to perform detection. A time T3 is a time period in which Det is H, and even while this pulse is output, Fix is not released. That is, the relationship T1≧T2+T3 holds.

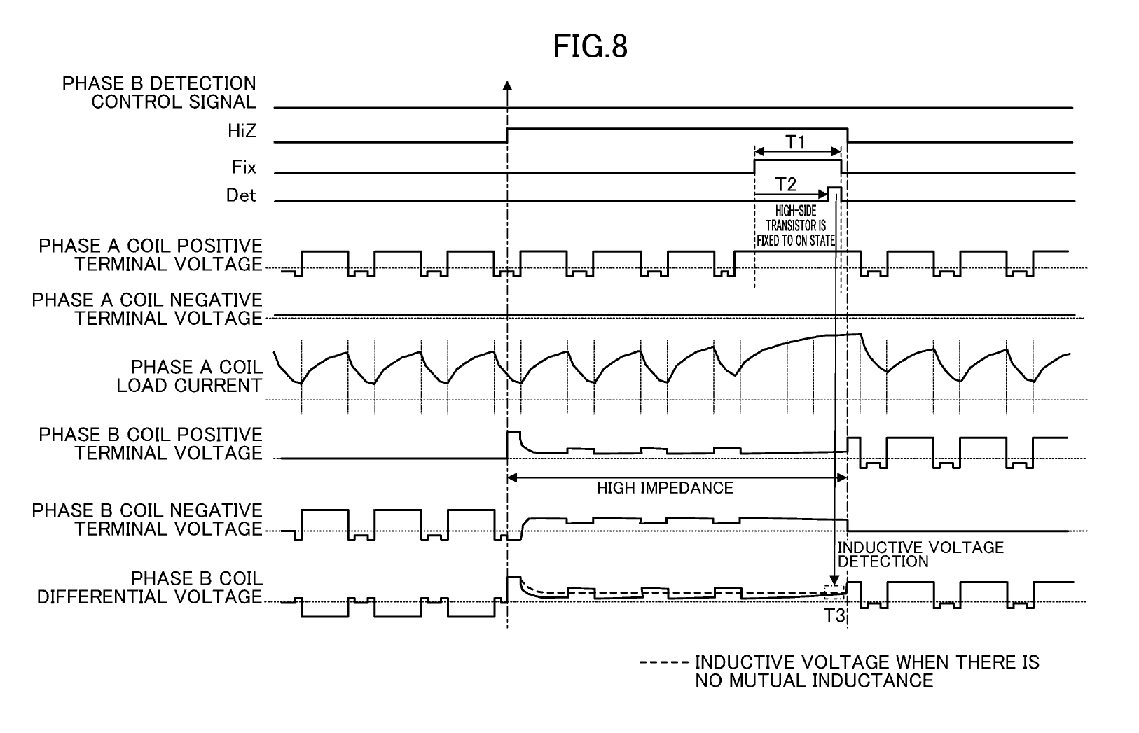

Next, an operation of the stepping motor drive unit of this embodiment will be described with reference to FIG. 8. Detection of an inductive voltage of the phase B coil 102 will be described below as an example. Immediately before detection is performed, each of the phase A output section 11′ and the phase B output section 12′ performs PWM driving to energize an associated one of the coils. When the phase B detection control signal is input, the both ends of the phase B coil 102 coupled to the phase B output section 12′ are caused to have high impedance. Since a residual current in the phase B coil 102 is regenerated by diodes, a differential voltage reaches a level equal to or higher than the power supply voltage, but after discharge is completed, the differential voltage starts converging to a value of an inductive voltage generated by rotation of the rotor 103. At this time, since the phase A coil 101 is driven in the PWM mode, a voltage due to mutual inductance is superimposed on an inductive voltage generated in the phase B coil 102. Thereafter, Fix is input to the phase A output section 11′, so that an output is fixed and energizing the phase A coil 101 is continued at least during T1. Since the coil has a time constant due to the inductance and resistance value, the amount of increase in current gradually reduces as energizing is continued. The mutual inductance is in proportion to a derivative value of a current, and therefore, when the amount of increase in current reduces, the influence of the mutual inductance reduces. After a lapse of a time T2 in which the influence of the mutual inductance is sufficiently reduced relative to the inductive voltage, Det is output. Accordingly, detection of an inductive voltage generated in the phase B coil 102 is performed, so that the influence of the mutual inductance can be reduced. It goes without saying that, since the amount of change in fixed energized state gradually reduces even in the direction in which an electric current reduces, similar advantages can be achieved. When detection is completed, the phase A output section 11′ restarts PWM driving of the phase A coil 101.

As described above, according to this embodiment, an inductive voltage can be detected with a timing at which the influence of mutual inductance is small. Thus, rotor stop determination can be performed with high accuracy. Also, in a motor for which stop determination conventionally has to be performed at relatively high rotation speed, determination can be performed at lower rotation speed.

Note that in each of the above-described embodiments, each of the phase A detection control section 13 and the phase B detection control section 14 may be configured to output, when receiving an associated one of the phase A detection control signal and the phase B detection control signal once, Fix through a plurality of separate outputs. Furthermore, each of the phase A detection control section 13 and the phase B detection control section 14 may be configured to output, when receiving an associated one of the phase A detection control signal and the phase B detection control signal once, Fix through a plurality of separate outputs so that an energized state of the phase A coil 101 and the phase B coil 102 can be either a state where a high-side transistor is fixed to an on state or a state where a low-side transistor is fixed to an on state. That is, when the phase A detection control section 13 and the phase B detection control section 14 receive the phase A detection control signal and the phase B detection control signal once, the phase A detection control section 13 and the phase B detection control section 14 may output Fix through a plurality of separate outputs in the manner shown in FIG. 3 or FIG. 7. Since the phase A input signal and the phase B input signal are out of phase with one another by 90 degrees, the stop determination section 17 alternately receives a detection result of the phase A inductive voltage detection section 15 and a detection result of the phase B inductive voltage detection section 16, as a motor is rotated. Thus, each time detection is performed, a latest detection result can be held and be output as a stop determination output. Therefore, rotor stop determination with higher accuracy can be performed based on results of a plurality of detections.

A target that the stepping motor drive unit of each of the above-described embodiments drives is not limited to a two-phase bipolar stepping motor. The above-described advantages can be achieved in driving a multiple-phase stepping motor.

What is claimed is:

1. A stepping motor drive unit which drives a stepping motor including coils having a plurality of phases, the stepping motor drive unit comprising:
a phase A output section configured to drive a phase A coil in a PWM mode according to a phase A input signal, cause, when receiving a high impedance control signal, both ends of the phase A coil to have high impedance regardless of the phase A input signal, and fix, when receiving an energized state fixing signal, an energized state of the phase A coil regardless of the phase A input signal;
a phase B output section configured to drive a phase B coil in a PWM mode according to a phase B input signal, cause, when receiving a high impedance control signal, both ends of the phase B coil to have high impedance regardless of the phase B input signal, and fix, when receiving an energized state fixing signal, an energized state of the phase B coil regardless of the phase B input signal;
a phase A detection control section configured to receive a phase A detection control signal to output the high impedance control signal to the phase A output section and output the energized state fixing signal to the phase B output section;
a phase B detection control section configured to receive a phase B detection control signal to output the high impedance control signal to the phase B output section and output the energized state fixing signal to the phase A output section;
a phase A inductive voltage detection section configured to receive a detection period signal to detect a voltage across the both ends of the phase A coil;
a phase B inductive voltage detection section configured to receive a detection period signal to detect a voltage across the both ends of the phase B coil; and
a stop determination section configured to determine, based on determination results of the phase A inductive voltage detection section and the phase B inductive voltage detection section, whether a rotor of the stepping motor is stopped or not,
wherein
the phase A output section outputs, after receiving the energized state fixing signal from the phase B detection control section, the detection period signal to the phase B inductive voltage detection section in synchronization with a driving timing of the phase A coil, and
the phase B output section outputs, after receiving the energized state fixing signal from the phase A detection control section, the detection period signal to the phase A inductive voltage detection section in synchronization with a driving timing of the phase B coil.

2. The stepping motor drive unit of claim 1, wherein
the phase A output section drives the phase A coil in the PWM mode according to the phase A input signal during a period from reception of the energized state fixing signal from the phase B detection control section to synchronization with the driving timing of the phase B coil, and fixes the energized state of the phase A coil during a period from the synchronization with the driving timing of the phase B coil at least to completion of output of the detection period signal, and
the phase B output section drives the phase B coil in the PWM mode according to the phase B input signal during a period from reception of the energized state fixing signal from the phase A detection control section to synchronization with the driving timing of the phase A coil, and fixes the energized state of the phase B coil during a period from the synchronization with the driving timing of the phase A coil at least to completion of output of the detection period signal.

3. A stepping motor drive unit which drives a stepping motor including coils having a plurality of phases, the stepping motor drive unit comprising:
a phase A output section configured to drive a phase A coil in a PWM mode according to a phase A input signal, cause, when receiving a high impedance control signal, both ends of the phase A coil to have high impedance regardless of the phase A input signal, and fix, when receiving an energized state fixing signal, an energized state of the phase A coil regardless of the phase A input signal;
a phase B output section configured to drive a phase B coil in a PWM mode according to a phase B input signal, cause, when receiving a high impedance control signal, both ends of the phase B coil to have high impedance regardless of the phase B input signal, and fix, when receiving an energized state fixing signal, an energized state of the phase B coil regardless of the phase B input signal;
a phase A detection control section configured to receive a phase A detection control signal to output the high impedance control signal to the phase A output section and output the energized state fixing signal to the phase B output section;
a phase B detection control section configured to receive a phase B detection control signal to output the high impedance control signal to the phase B output section and output the energized state fixing signal to the phase A output section;
a phase A inductive voltage detection section configured to receive a detection period signal to detect a voltage across the both ends of the phase A coil;
a phase B inductive voltage detection section configured to receive a detection period signal to detect a voltage across the both ends of the phase B coil;
a phase A detection period control section configured to receive the energized state fixing signal from the phase A detection control section to output the detection period signal to the phase A inductive voltage detection section;
a phase B detection period control section configured to receive the energized state fixing signal from the phase B detection control section to output the detection period signal to the phase B inductive voltage detection section; and
a stop determination section configured to determine, based on determination results of the phase A inductive voltage detection section and the phase B inductive voltage detection section, whether a rotor of the stepping motor is stopped or not.

4. The stepping motor drive unit of claim 3, wherein
the phase A detection period control section outputs the detection period signal after a lapse of a predetermined time from the reception of the energized state fixing signal from the phase A detection control section, and
the phase B detection period control section outputs the detection period signal after a lapse of a predetermined time from the reception of the energized state fixing signal from the phase B detection control section.

5. The stepping motor drive unit of claim 1, wherein
the phase A detection control section and the phase B detection control section each output the energized state fixing signal after a lapse of a predetermined time from output of the high impedance control signal.

6. The stepping motor drive unit of claim 3, wherein
the phase A detection control section and the phase B detection control section each output the energized state fixing signal after a lapse of a predetermined time from output of the high impedance control signal.

7. The stepping motor drive unit of claim 1, wherein
when the phase A detection control section receives the phase A detection control signal once, the phase A detection control section outputs the energized state fixing signal through a plurality of separate outputs,
when the phase B detection control section receives the phase B detection control signal once, the phase B detection control section outputs the energized state fixing signal through a plurality of separate outputs, and
the stop determination section determines, based on detection results of the plurality of detections by the phase A inductive voltage detection section and the phase B inductive voltage detection section, whether the rotor of the stepping motor is stopped or not.

8. The stepping motor drive unit of claim 3, wherein
when the phase A detection control section receives the phase A detection control signal once, the phase A detection control section outputs the energized state fixing signal through a plurality of separate outputs,
when the phase B detection control section receives the phase B detection control signal once, the phase B detection control section outputs the energized state fixing signal through a plurality of separate outputs, and
the stop determination section determines, based on detection results of the plurality of detections by the phase A inductive voltage detection section and the phase B inductive voltage detection section, whether the rotor of the stepping motor is stopped or not.

9. The stepping motor drive unit of claim 7, wherein
when the phase A detection control section receives the phase A detection control signal once, the phase A detection control section outputs the energized state fixing signal through a plurality of separate outputs so that the energized state of the phase B coil becomes a state where a high-side transistor is fixed to an on state or a state where a low-side transistor is fixed to an on state, and
when the phase B detection control section receives the phase B detection control signal once, the phase B detection control section outputs the energized state fixing signal through a plurality of separate outputs so that the energized state of the phase A coil becomes a state where a high-side transistor is fixed to an on state or a state where a low-side transistor is fixed to an on state.

10. The stepping motor drive unit of claim 8, wherein
when the phase A detection control section receives the phase A detection control signal once, the phase A detection control section outputs the energized state fixing signal through a plurality of separate outputs so that the energized state of the phase B coil becomes a state where a high-side transistor is fixed to an on state or a state where a low-side transistor is fixed to an on state, and
when the phase B detection control section receives the phase B detection control signal once, the phase B detection control section outputs the energized state fixing signal through a plurality of separate outputs so that the energized state of the phase A coil becomes a state where a high-side transistor is fixed to an on state or a state where a low-side transistor is fixed to an on state.

11. A stepping motor drive unit which drives a stepping motor including coils having a plurality of phases, and has functions of causing both ends of one of the coils having one of the plurality of phases to have high impedance to detect an inductive voltage in the coil, and determining a rotation/stop state of the stepping motor based on a result of the detection,
wherein
the stepping motor drive unit has a function of temporarily stopping, while causing the both ends of the coil having the one of the plurality of phases to have high impedance, PWM driving of at least one of the other coils to fix an energized state of the coil.
